(19) United States
(12) Patent Application Publication
(10) Pub. No.: US 2024/0008541 A1
(43) Pub. Date: Jan. 11, 2024

(54) ELECTRONIC HEATING DEVICE

(71) Applicant: SHENZHEN RELX TECHNOLOGY CO., LTD., ShenZhen (CN)

(72) Inventor: YANG-YUN JIN, Shenzhen (CN)

(21) Appl. No.: 18/371,420

(22) Filed: Sep. 21, 2023

Related U.S. Application Data
(63) Continuation-in-part of application No. PCT/CN2021/134829, filed on Dec. 1, 2021.

(30) Foreign Application Priority Data
Mar. 24, 2021 (CN) 202120605171.2

(51) Int. Cl. A24F 40/46; A24F 40/20; A24F 40/85

(52) U.S. Cl. CPC A24F 40/46; A24F 40/20; A24F 40/85

(57) ABSTRACT

An electronic heating device includes a housing; and a first electric terminal, a second electric terminal, a storage cup, and a heating circuit. Both the first electric terminal and the second electric terminal are disposed in the housing. The second electric terminal is movable between a first position and a second position in a direction toward or away from the first electric terminal respectively. The storage cup is movable in the direction toward or away from the first electric terminal, and the storage cup can drive the second electric terminal to move between the first position and the second position. The heating circuit is used for heating a receiving cavity of the storage cup. The first electric terminal and the second electric terminal are electrically connected to the heating circuit.

### CROSS-REFERENCE TO RELATED APPLICATIONS

This application is a continuation-in-part under 35 U.S.C. § 120 of international patent application PCT/CN2021/134829 filed Dec. 01, 2021, which claims priority to China Application No. 202120605171.2, having a filing date of Mar. 24, 2021, filed in China National Intellectual Property Administration, the entire contents of which are hereby incorporate by reference.

### FIELD

The subject matter relates to a technical field of electronic heating devices, and in particular to an electronic heating device.

### BACKGROUND

Electronic heating devices in the related art for heating a member usually include a first electric terminal, a second electric terminal, and a circuit electrically connected to the first electric terminal and the second electric terminal. The electronic heating devices may further be equipped with sensors or detectors to detects a position signal of the member, and the sensors or the detectors cooperates with the circuit to control a movement of the second electric terminal so as to realize an on-off switch with the first electric terminal. However, the cost of the above described heating method is high, and the control reliability of the above method may not be enough.

Therefore, there is room for improvement within the art.

### SUMMARY

The present disclosure provides an electronic heating device that is low cost and reliable.

An embodiment of an electronic heating device according to the present disclosure, includes a housing, a first power connection portion arranged in the housing, a second power connection portion arranged in the housing, a storage cup, and a heating circuit. The first power connection portion includes a first electric terminal. The second power connection portion includes a second electric terminal. The second electric terminal is movable between a first position and a second position in a direction toward or away from the first electric terminal respectively. The second electric terminal is in electrically contact with the first electric terminal when the second electric terminal is at the first position. The electric terminal is disconnected from the first electric terminal when the second electric terminal is at the second position. The storage cup includes a receiving cavity configured for storing a to-be-heated member. The storage cup is movable in the direction toward or away from the first electric terminal to drive the second electric terminal to move between the first position and the second position respectively. The heating circuit is used for heating the receiving cavity. The first electric terminal and the second electric terminal are electrically connected to the heating circuit.

Other aspects and embodiments of the present disclosure are also expected. The above summary and the following detailed description are not intended to limit the present disclosure to any particular embodiment, but are merely intended to describe some embodiments of the present disclosure.

### BRIEF DESCRIPTION OF THE DRAWINGS

Implementations of the present disclosure will now be described, by way of embodiments, with reference to the attached figures.

FIG. 1 is a diagrammatic view of an embodiment of an electronic heating device with a to-be-heated member according to the present disclosure.

FIG. 2 is a side diagrammatic view of the electronic heating device with the to-be-heated member in FIG. 1.

FIG. 3 is a cross-sectional view of the electronic heating device with the to-be-heated member taken along X-X line of FIG. 2.

FIG. 4 is a partial enlarged view of the electronic heating device with the to-be-heated member of FIG. 3.

FIG. 5 is a diagrammatic view of the electronic heating device with the to-be-heated member of FIG. 1 viewed from another angle.

FIG. 6 is an exploded view of the electronic heating device with the to-be-heated member of FIG. 5.

FIG. 7 is a partially exploded view of the electronic heating device of FIG. 6.

FIG. 8 is another partially exploded view of the electronic heating device of FIG. 6.

FIG. 9 is a cross-sectional view of the electronic heating device of FIG. 1 in a state.

FIG. 10 is a cross-sectional view of the electronic heating device of FIG. 1 in another state.

FIG. 11 is a cross-sectional view of the electronic heating device of FIG. 1 in yet another state.

FIG. 12 is a cross-sectional view of the electronic heating device of FIG. 1 in yet another state.

### DETAILED DESCRIPTION

The embodiments of the present application will be described in detail below. Throughout the specification, the same or similar components and components having the same or similar functions are denoted by similar reference numerals. The embodiments described herein with respect to the drawings are illustrative, and are used for providing a basic understanding of the present application. The embodiments of the present application should not be interpreted as limitations to the present application.

The following description provides various embodiment or examples to implement different structures of the present application. Only specific components and configurations in the embodiment or examples are described below for simplicity. Of course, they are only examples and are not considered as limiting the scope of the present application. In addition, reference numerals have been repeated among different embodiments or examples to indicate corresponding or analogous members for simplicity, and are not intended to indicate the relationship among the different embodiments or examples discussed herein. In addition, the present application also provides examples of various specific processes and materials, but one having ordinary skill in the art will realize that other processes and materials may also be used.

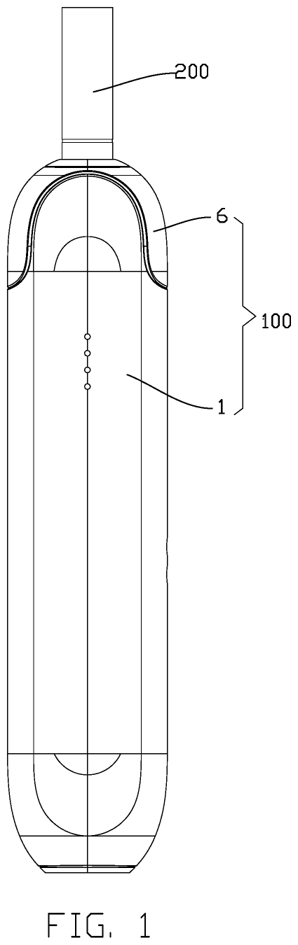

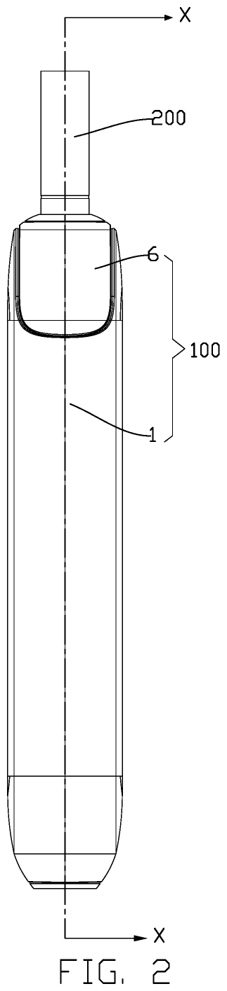

Referring to FIGS. 1 to 4, an embodiment of an electronic heating device 100 includes a housing 1, a first power connection portion 2, a second power connection portion 3, a storage cup 4, and a heating circuit 5. The first power connection portion 2 is received in the housing 1 and includes a first electric terminal 21. The second power connection portion 3 is received in the housing 1 and includes a second electric terminal 31. The second electric terminal 31 is movable between a first position and a second position in a direction toward or away from the first electric terminal 21 respectively. When the second electric terminal 31 is at the first position, the second electric terminal 31 is in electrically contact with the first electric terminal 21. When the second electric terminal 31 is at the second position, the second electric terminal 31 is disconnected from the first electric terminal 21. The storage cup 4 includes a receiving cavity 41 for storing a to-be-heated member 200 that needs to be heated. The storage cup 4 is movable in the direction toward or away from the first electric terminal 21 to drive the second electric terminal 31 to move between the first position and the second position respectively. The heating circuit 5 is used for heating the receiving cavity 41. The first electric terminal 21 and the second electric terminal 31 are electrically connected to the heating circuit 5.

It should be noted that “the storage cup 4 is movable in a direction toward or away from the first electric terminal 21 to drive the second electric terminal 31 to move between the first position and the second position” described herein refers to, the storage cup 4 and the second electric terminal 31 move synchronously, the storage cup 4 can drive the second electric terminal 31 to move toward the first position and can also drive the second electric terminal 31 to move toward the second position. When the second electric terminal 31 is at the first position, the second electric terminal 31 can be driven away from the first position and toward the second position by pushing the storage cup 4. When the second electric terminal 31 is at the second position, the second electric terminal 31 can be driven away from the second position and toward the first position by pulling the storage cup 4. That is to say, at least part of a driving force for driving the second electric terminal 31 to move between the first position and the second position comes from the storage cup 4 That is, all of the driving force comes from the storage cup 4, or only a part of the driving force comes from the storage cup 4 and the rest of the driving force may come from a magnetic attraction force, a spring force or others.

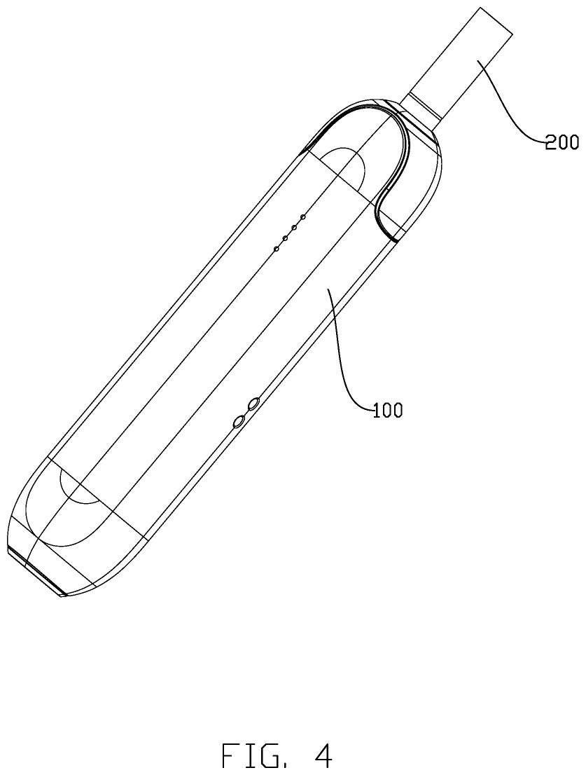

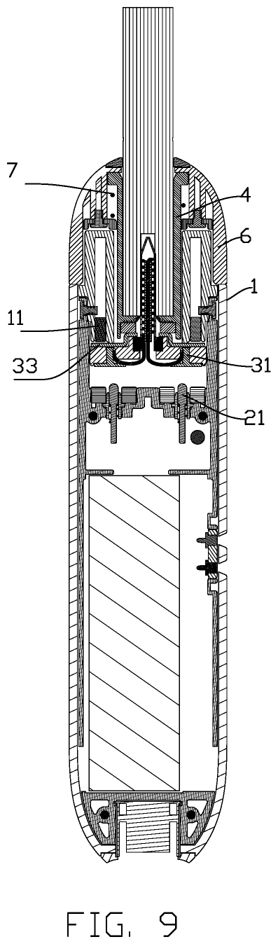

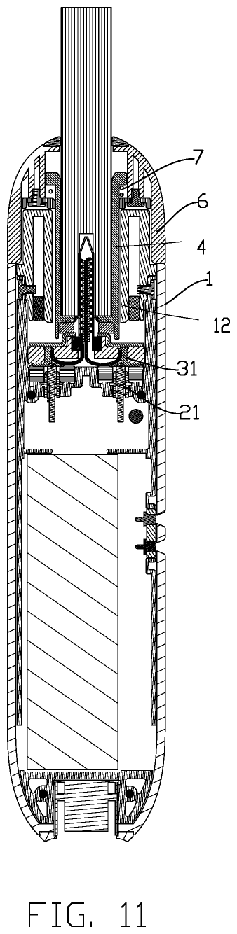

When the second electric terminal 31 reaches the first position, the heating circuit 5 is in a closed state through an electrical contact between the first electric terminal 21 and the second electric terminal 31, as shown in FIG. 11. If current is supplied to the heating circuit 5, the heating circuit 5 can heat the to-be-heated member 200 inserted in the receiving cavity 41. When the second electric terminal 31 reaches the second position, the heating circuit 5 is in an open-circuit state due to a separation of the first electric terminal 21 and the second electric terminal 31, as shown in FIG. 4 and FIG. 9. Even if current is supplied to the heating circuit 5, the heating circuit 5 cannot heat the to-be-heated member 200 inserted in the receiving cavity 41.

Therefore, in the above-mentioned electronic heating device 100, there is no need to install sensors or detectors, and a switching of an electrical connection and an electrical disconnection between the first electric terminal 21 and the second electric terminal 31 are controlled by moving the second electric terminal 31, thereby reducing costs and improving the reliability of control. In addition, since both the first power connection portion 2 and the second power connection portion 3 are located in the housing 1 and protected by the housing 1, the first power connection portion 2 or the second power connection portion 3 is prevented from moving out of the housing 1 and being damaged by external factors, thereby improving a service life of the electronic heating device 100.

In at least one embodiment, referring to FIG. 4, the first power connection portion 2 and the storage cup 4 are respectively located on opposite sides of the second power connection portion 3 across a direction that the second electric terminal 31 is moving. Therefore, a structure of the electronic heating device 100 is simple and an operation of the electronic heating device 100 is labor-saving, which facilitates the heating of the to-be-heated member 200 in the storage cup 4. It should be noted that the entire second power connection portion 3 may be movable, and the entire first power connection portion 2 may be immovable, that is, a moving direction of the second power connection portion 3 is the moving direction of the second electric terminal 31. For example, referring to FIG. 4, the storage cup 4 is located above the second power connection portion 3, and the first power connection portion 2 is located below the second power connection portion 3. The entire second power connection portion 3 can be pushed by the storage cup 4 to move downward, which can drive the second electric terminal 31 to reach the first position to be in electrical contact with the first electric terminal 21. The entire second power connection portion 3 can be pulled by the storage cup 4 to move up, which can drive the second electric terminal 31 to reach the second position to be disconnected from the first electric terminal 21.

In at least one embodiment, in an initial state, the first power connection portion 2 and the storage cup 4 may be located on the same side of the second power connection portion 3. For example, the storage cup 4 may pull the second electric terminal 31 upward to a first upward position, the first upward position is the first position where the second electric terminal 31 is in electrical contact with the first electric terminal 21. At this time, the first electric terminal 21 may surround an outer periphery of the second electric terminal 31 and be in electrical contact with the second electric terminal 31. When the storage cup 4 continues to pull the second electric terminal 31 to continue to move upward from the first upward position to a second upward position, the second upward position is the second position where the second electric terminal 31 is disconnected from the first electric terminal 21.

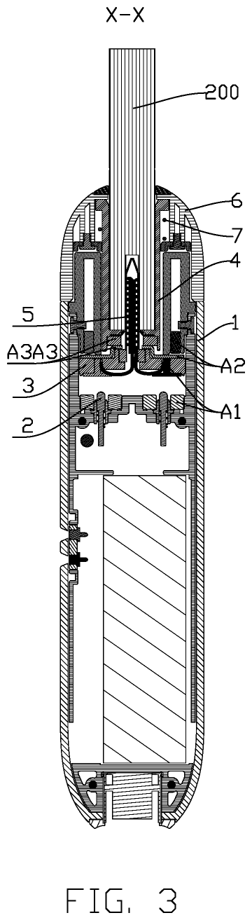

In at least one embodiment, referring to FIG. 3 and FIG. 4, the electronic heating device 100 may further include a first locking portion A1 for locking the second electric terminal 31 at the first position when the second electric terminal 31 is at the first position. Thus, a stability and reliability of the electrical contact between the first electric terminal 21 and the second electric terminal 31 can be improved through the first locking portion A1, and a stability and reliability of heating the to-be-heated member 200 inserted in the receiving cavity 41 by the heating circuit 5 can be improved through the first locking portion A1.

In at least one embodiment, referring to FIG. 3 and FIG. 4, the first locking portion A1 may lock the second electric terminal 31 at the first position by a magnetic attraction force. A method of locking and unlocking the second electric terminal 31 through magnetic attraction is simple and easy to implement, and an operation of the method of locking and unlocking the second electric terminal 31 is very flexible. In at least one embodiment, the second electric terminal 31 may be locked or unlocked through a buckle assembly or others.

In at least one embodiment, referring to FIG. 3 and FIG. 4, the first locking portion A1 may include a first magnetic part 32 and a second magnetic part 22 that magnetically cooperate with each other. The first magnetic part 32 is provided by the second power connection portion 3, and the second magnetic part 22 is provided by the first power connection portion 2, that is, the second power connection portion 3 includes the first magnetic part 32, and the first power connection portion 2 includes the second magnetic part 22. When the second power connection portion 3 is moved until the first magnetic part 32 and the second magnetic part 22 are magnetically attracted to each other, the second electric terminal 31 is in electrical contact with the first electric terminal 21 and the second electric terminal 31 is locked at the first position. It should be noted that a magnetic adsorption between the first magnetic part 32 and the second magnetic part 22 may be an adsorption between magnets, an adsorption between a magnet and a metal part, an adsorption between electromagnets, or an adsorption between an electromagnet and a metal part, etc., which is not limited here.

In at least one embodiment, an end of the second power connection portion 3 facing the first power connection portion 2 may include the first magnetic part 32, and the first magnetic part 32 and the first power connection portion 2 are arranged along the moving direction of the second electric terminal 31. For example, referring to FIG. 4, the first power connection portion 2 is located below the second power connection portion 3, and a lower end of the second power connection portion 3 includes the first magnetic part 32. Therefore, the first locking portion A1 has a simple structure and is convenient for realizing of magnetic attraction and ensuring the magnetic effect.

In at least one embodiment, referring to FIG. 4, the first magnetic part 32 and the second electric terminal 31 may be integrated into a piece, that is, the first magnetic part 32 may be integrated with the second electric terminal 31. For example, the first magnetic part 32 may be located inside the second electric terminal 31 or located outside the second electric terminal 31. An integration of first magnetic part 32 and the second electric terminal 31 is beneficial to simplify the structure of the electronic heating device 100. In at least one embodiment, the first magnetic part 32 and the second electric terminal 31 may be separate parts and not directly connected to each other.

In at least one embodiment, referring to FIG. 3 and FIG. 4, the electronic heating device 100 may further include a second locking portion A2 for locking the second electric terminal 31 at the second position when the second electric terminal 31 is at the second position. Thus, a stability and reliability of a disconnection between the first electric terminal 21 and the second electric terminal 31 can be improved through the second locking portion A2, and a stability and reliability of stopping heating the receiving cavity 41 by the heating circuit 5 can be improved through the second locking portion A2.

In at least one embodiment, referring to FIG. 3 and FIG. 4, the second locking portion A2 may lock the second electric terminal 31 at the second position by a magnetic attraction force. A method of locking and unlocking the second electric terminal 31 at the second position through magnetic attraction is simple and easy to implement, and an operation of the method of locking and unlocking the second electric terminal 31 at the second position is very flexible. In at least one embodiment, the second electric terminal 31 may be locked or unlocked at the second position through a buckle assembly or others.

In at least one embodiment, referring to FIG. 3 and FIG. 4, the second locking portion A2 may include a third magnetic part 33 and a fourth magnetic part 11. The third magnetic part 33 is provided by the second power connection portion 3, and the fourth magnetic part 11 is provided by the housing 1, that is, the second power connection portion 3 includes the third magnetic part 33, and the housing 1 includes the fourth magnetic part 11. When the second power connection portion 3 is moved until the third magnetic part 33 and the fourth magnetic part 11 are magnetically attracted to each other, the second electric terminal 31 is disconnected from the first electric terminal 21 and the second electric terminal 31 is locked at the second position. It should be noted that a magnetic adsorption between the third magnetic part 33 and the fourth magnetic part 11 may be an adsorption between magnets, an adsorption between a magnet and a metal part, an adsorption between electromagnets, or an adsorption between an electromagnet and a metal part, etc., which is not limited here.

In at least one embodiment, an end of the second power connection portion 3 facing away from the first power connection portion 2 may include the third magnetic part 33, and the third magnetic part 33 and the first power connection portion 2 may be arranged along the moving direction of the second electric terminal 31. For example, referring to FIG. 4, the first power connection portion 2 is located below the second power connection portion 3, and an upper end of the second power connection portion 3 includes the third magnetic part 33. Therefore, the second locking portion A2 has a simple structure and is convenient for realizing of magnetic attraction and ensuring the magnetic effect.

In at least one embodiment, referring to FIG. 4, the housing 1 may further include a frame 12 for supporting the storage cup 4, and the fourth magnetic part 11 may be located on the frame 12. The frame 12 can be used to install the fourth magnetic part 11 simply and effectively, so that a structure of the housing 1 may be more compact and smaller. It should be noted that the housing 1 may further include a shell 13, the frame 12 is received in the shell 13. The first power connection portion 2 and the second power connection portion 3 are received in the shell 13. The fourth magnetic part 11 is installed on the frame 12 and the frame 12 supports the storage cup 4.

In at least one embodiment, referring to FIG. 3 and FIG. 4, the electronic heating device 100 may further include a third locking portion A3 for detachably connecting the second power connection portion 3 and the storage cup 4, that is, the second power connection portion 3 and the storage cup 4 are detachably connected through the third locking portion A3. When the third locking portion A3 is in a locked state, the second power connection portion 3 and the storage cup 4 are connected together. When the third locking portion A3 is in an unlocked state, the second power connection portion 3 is disconnected from the storage cup 4, and the storage cup 4 can be removed from the second power connection portion 3 and separated from the housing 1. Therefore, the storage cup 4 can be removed as needed to perform operations such as cleaning on the storage cup 4. It should be noted that, since the second power connection portion 3 and the storage cup 4 are detachable, when the storage cup 4 is removed from the housing 1, the second power connection portion 3 is still retained in the housing 1, so that the second power connection portion 3 can always be protected by the housing 1.

In at least one embodiment, referring to FIG. 3 and FIG. 4, the third locking portion A3 may lock the second power connection portion 3 and the storage cup 4 together with each other by magnetic attraction. A method of locking and unlocking the second power connection portion 3 and the storage cup 4 through magnetic attraction is simple and easy to implement, and an operation of the method of locking and unlocking the storage cup 4 is very flexible. In at least one embodiment, the storage cup 4 may be locked or unlocked through a buckle assembly or others.

In at least one embodiment, referring to FIG. 3 and FIG. 4, the third locking portion A3 may include a fifth magnetic part 34 and a sixth magnetic part 42 that magnetically cooperate each other. The fifth magnetic part 34 is provided by the second power connection portion 3, and the sixth magnetic part 42 is provided by the storage cup 4, that is, the second power connection portion 3 includes the fifth magnetic part 34, and the storage cup 4 includes the sixth magnetic part 42. The storage cup 4 includes a cup body 43 defining the receiving cavity 41. The sixth magnetic part 42 is installed on the cup body 43. When the fifth magnetic part 34 and the sixth magnetic part 42 are magnetically attracted to each other, the storage cup 4 and the second power connection portion 3 are locked together and move synchronously. It should be noted that a magnetic adsorption between the fifth magnetic part 34 and the sixth magnetic part 42 may be an adsorption between magnets, an adsorption between a magnet and a metal part, an adsorption between electromagnets, or an adsorption between an electromagnet and a metal part, etc., which is not limited here.

In at least one embodiment, the end of the second power connection portion 3 facing the storage cup 4 may include the fifth magnetic part 34, and the fifth magnetic part 34 and the storage cup 4 may be arranged along the moving direction of the second electric terminal 31. For example, referring to FIG. 4, the storage cup 4 is located above the second power connection portion 3, and the upper end of the second power connection portion 3 further includes the fifth magnetic part 34. Therefore, the third locking portion A3 has a simple structure and is convenient for realizing of magnetic attraction and ensuring the magnetic effect. In at least one embodiment, the fifth magnetic part 34 may be integrated with the third magnetic part 33, thereby simplifying the structure of the electronic heating device 100 and improving the compactness of the electronic heating device 100 in structure. For example, referring to FIG. 4, the fifth magnetic part 34 and the third magnetic part 33 are integrated into a piece and the piece is fixed on the second electric terminal 31 in a sheet shape, which is convenient for processing and has a smaller thickness, thereby improving the compactness of the electronic heating device 100 in structure. The piece may be a steel sheet or an iron sheet. In at least one embodiment, the piece may be in other shapes. In at least one embodiment, the fifth magnetic part 34 and the third magnetic part 33 may be separated from each other, and each of the fifth magnetic part 34 and the third magnetic part 33 may be in any shape.

In at least one embodiment, the electronic heating device 100 may further include a cover 6 located at an end of the housing 1 and on a side of the second electric terminal 31 away from the first position in the moving direction of the second electric terminal 31. For example, referring to FIG. 4, when the storage cup 4 moves upward, the second electric terminal 31 is driven to move toward the second position. At least part of the cover 6 is located at an upper end of the storage cup 4. The cover 6 is detachably mounted on the housing 1. The storage cup 4 is installed on the cover 6 and can be separated from the housing 1 as the cover 6 is detached from the housing 1, that is to say, the cover 6 and the housing 1 cooperate to receive the storage cup 4. When the cover 6 is mounted on the housing 1, the storage cup 4 is mounted in the housing 1 and locked with the second power connection portion 3. When the cover 6 is removed from the housing 1, the storage cup 4 can be separated from the second power connection portion 3 and removed from the housing 1 together with the cover 6. The cover 6 can protect the storage cup 4 and can seal and shield the storage cup 4, and further can facilitate the indirect disassembly and assembly of the storage cup 4 and the housing 1.

In at least one embodiment, the storage cup 4 may be movably installed on the cover 6, and a resetting member 7 may be arranged between the storage cup 4 and the cover 6. When the cover 6 is mounted on the housing 1, the resetting member 7 may be further arranged between the storage cup 4 and the housing 1. Referring to FIGS. 9 to 11, when the storage cup 4 and the second electric terminal 31 are moved toward the first position, the resetting member 7 is compressed and provides a restoring force to the second electric terminal 31, and the restoring force is configured to move the second electric terminal 31 toward the second position. For example, when the storage cup 4 is moved downward relative to the cover 6, the second electric terminal 31 is driven to the move toward the first position, at this time, the resetting member 7 is compressed by the downward movement of the storage cup 4 relative to the cover 6, so that the resetting member 7 can provide the restoring force for the storage cup 4, and the restoring force is configured to move the storage cup 4 upward relative to the cover 6 to drive the second electric terminal 31 to move toward the second position. Therefore, the resetting member 7 can save the user's operation effort, that is, the user does not need to always pull the storage cup 4 by hand, but can use the restoring force of the resetting member 7 to drive the second electric terminal 31 to move toward the second position.

In at least one embodiment, the cover 6 may be movably mounted on the housing 1, and the cover 6 may move synchronously with the storage cup 4. The resetting member 7 may be arranged between the housing 1 and the cover 6. When the storage cup 4 is moved relative to the cover 6 to drive the second electric terminal 31 to move toward the first position, the resetting member 7 is compressed and provides the restoring force to drive the second electric terminal 31 to move toward the second position. Therefore, the resetting member 7 can save the user's operation effort, that is, the user does not need to always pull the storage cup 4 by hand, but can use the restoring force of the resetting member 7 to drive the second electric terminal 31 to move toward the second position.

In at least one embodiment, referring to FIG. 4, the second power connection portion 3 may further include a support base 35 for mounting the second electric terminal 31. The heating circuit 5 includes a heating element 51 fixed to the support base 35. The heating circuit 5 is used for heating the receiving cavity 41 through the heating element 51. When the storage cup 4 is moved to drive the second electric terminal 31 to move, the support base 35 is driven to move together with the second electric terminal 31, so that the heating element 51 fixed to the support base 35 is driven to move together with the storage cup 4, that is, the heating element 51 and the receiving cavity 41 of the storage cup 4 may be relatively stationary, so that the receiving cavity 41 may be heated stably by the heating element 51. In at least one embodiment, the receiving cavity 41 of the storage cup 4 may be heated through a heating structure that is relatively movable with the storage cup 4. For example, the heating structure may be arranged on the frame 12. When the second electric terminal 31 is at the first position, the storage cup 4 is stationary relative to the heating structure, so that a reliable heating effect can also be ensured.

In at least one embodiment, at least part of the heating element 51 may extend into the storage cup 4, and an extending direction of the at least part of the heating element 51 is the same as a moving direction of the storage cup 4, thereby ensuring a longer length of the at least part of the heating element 51, improving the heating effect and facilitating assembly.

In at least one embodiment, the storage cup 4 may further be provided with a cleaning blade 44, that is, the storage cup 4 may further include the cleaning blade 44. The cleaning blade 44 has a scraping head for abutting against the heating element 51. When the storage cup 4 is removed from the housing 1, the heating element 51 is scraped by the cleaning blade 44 as the storage cup 4 moves. In this way, the heating element 51 can be cleaned and scraped dirt may be left on the removed storage cup 4, thereby facilitating cleaning. The scraping head may extend into the receiving cavity 41, which is beneficial to ensure that the scraped dirt remains in the receiving cavity 41, so that the scraped dirt may be easy cleaned after the storage cup 4 is removed.

In at least one embodiment, an end of the storage cup 4 facing the second power connection portion 3 includes an end surface, and a through hole 45 is defined by the end surface. The heating element 51 is movably inserted into the storage cup 4 through the through hole 45. The cleaning blade 44 is arranged in the through hole 45 and surrounds the heating element 51. Therefore, the heating element 51 and the cleaning blade 44 can be assembled simply and effectively, thereby improving the cleaning effect of the cleaning blade 44 on the heating element 51.

In at least one embodiment, a direction in which the to-be-heated member 200 is inserted into the receiving cavity 41 is a direction in which the storage cup 4 pushes the second electric terminal 31 to move toward the first position. In the embodiment of the present application, an end of the storage cup 4 facing away from the second power connection portion 3 defines an opening for inserting the to-be-heated member 200, and the opening communicates with the receiving cavity 41 along the moving direction of the storage cup 4, so that when the to-be-heated member 200 is inserted into the receiving cavity 41 through the opening, the storage cup 4 can be pushed to move by the to-be-heated member 200 to drive the second electric terminal 31 to move toward the first position. That is to say, an action of inserting the to-be-heated member 200 into the receiving cavity 41 can push the second electric terminal 31 to the first position, and the to-be-heated member 200 can be heated when the heating circuit 5 is energized.

In at least one embodiment, a battery may be arranged in the housing 1, and the housing 1 may further include a battery holder 14 at least partially arranged in the shell 13. The battery is installed on the battery holder 14. In order to simplify the overall structure of the electronic heating device 100, a fixed terminal for electrically connecting the battery may be installed on the battery holder 14.

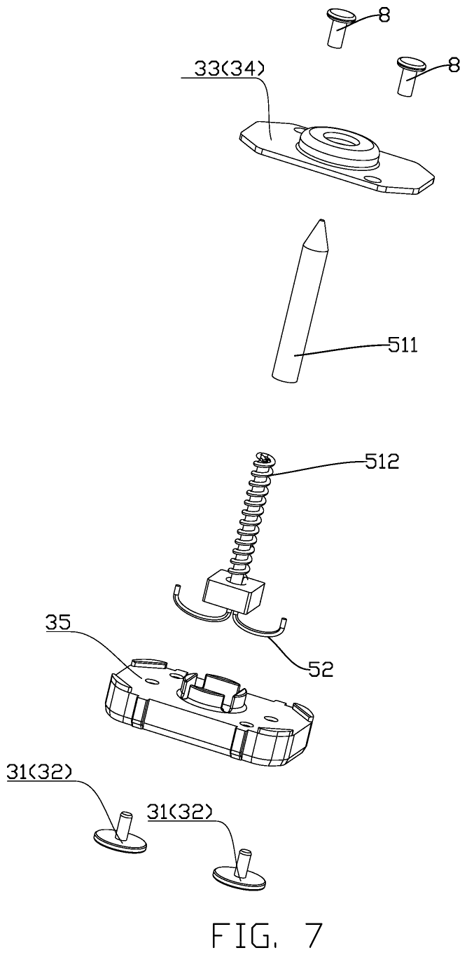

In at least one embodiment, referring to FIG. 4 and FIG. 7, the heating element 51 may include a heating needle 511 and a heating wire 512. The heating wire 512 is coiled inside the heating needle 511. The heating circuit 5 may further include a conductive member 52 connected to the heating wire 512 and the second electric terminal 31. A structure of the heating circuit 5 is simple, so that the to-be-heated member 200 may be easily heated, and the heating circuit 5 may be easily inserted into or extracted from the to-be-heated member 200.

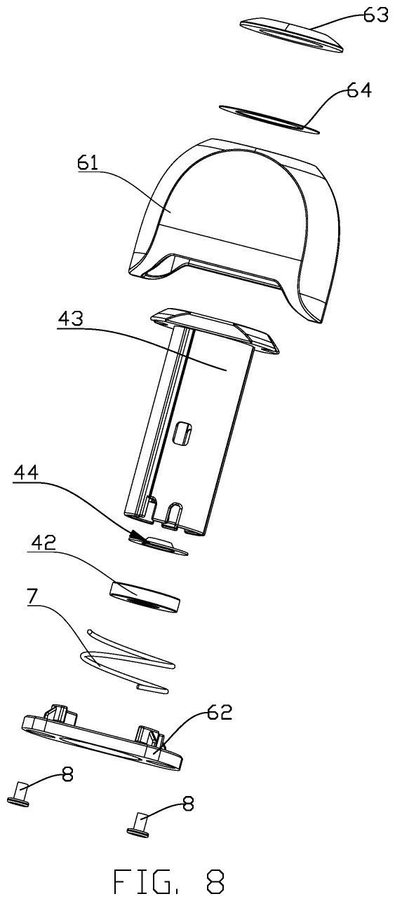

In at least one embodiment, referring to FIG. 4 and FIG. 8, the cover 6 may include a cover body 61, a cover bracket 62, a cover decoration 63, and an adhesive 64. The cover decoration 63 is pasted on an upper end of the cover body 61 through the adhesive 64. The cover bracket 62 may be fixedly connected to the cover body 61 through screws 8, so that the resetting member 7 is restricted to be sandwiched between the storage cup 4 and the cover bracket 62, thereby facilitating an installation of the resetting member 7.

An embodiment of the electronic heating device 100 according to the present disclosure is described below.

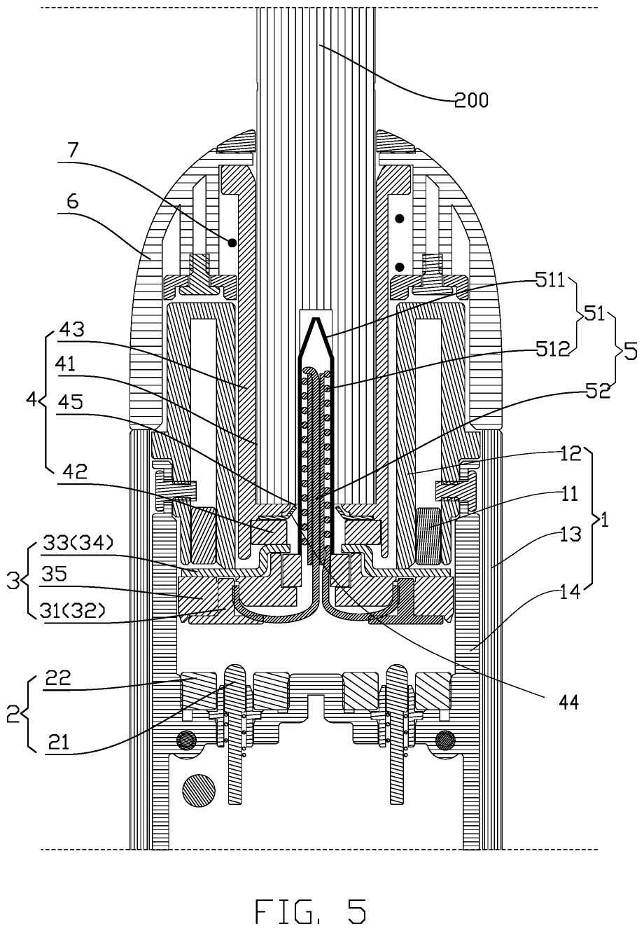

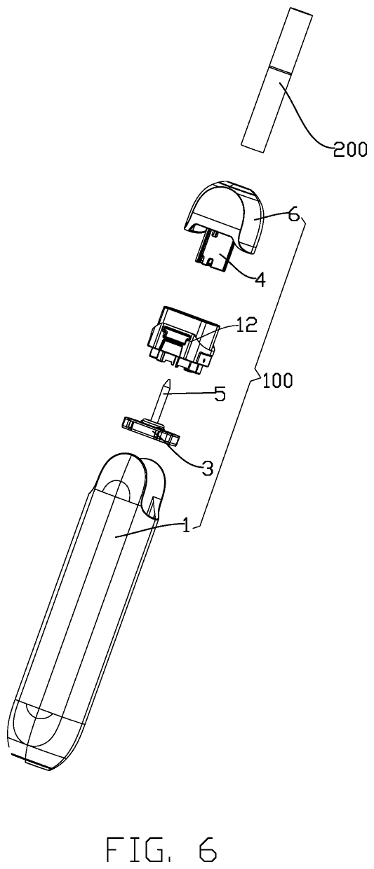

Referring to FIGS. 4 to 8, in the embodiment of the present disclosure, the electronic heating device 100 is a cigarette device, and the to-be-heated member 200 is a cigarette. The electronic heating device 100 uses the heating circuit 5 to heat the cigarette, thereby achieving an effect of heating without burning. The electronic heating device 100 includes the housing 1, the first power connection portion 2, the second power connection portion 3, the storage cup 4, the heating circuit 5, the cover 6, and the resetting member 7. The housing 1 includes the fourth magnetic part 11, the frame 12, and the shell 13. The first power connection portion 2 includes the first electric terminal 21 and the second magnetic part 22. The second power connection portion 3 includes the second electric terminal 31, the first magnetic part 32, the third magnetic part 33, the fifth magnetic part 34, and the support base 35. The storage cup 4 includes the sixth magnetic part 42, the cup body 43, and the cleaning blade 44. The heating circuit 5 includes the heating element 51. A connection relationship between the above components of the electronic heating device 100 may be referred to the above description and will not be described in detail here.

In at least one embodiment, the second magnetic part 22, the sixth magnetic part 42, and the fourth magnetic part 11 are magnets. The sixth magnetic part 42 and the fourth magnetic part 11 have the same magnetic poles. The third magnetic part 33 and the fifth magnetic part 34 are integrated into a steel sheet. The second electric terminal 31 and the first magnetic part 32 are integrated together. The resetting member 7 is a spring, and the first electric terminal 21 is a pogo pin. F2 is defined as a magnetic attraction force of the second magnetic part 22, F6 is defined as a magnetic attraction force of the sixth magnetic part 42, F4 is defined as a magnetic attraction force of the fourth magnetic part 11, F9 is defined as a repulsive force between the sixth magnetic part 42 and the fourth magnetic part 11, F7 is defined as an elastic force of the first power connection portion 2, F8 is defined as an elastic force of the resetting member 7, G is defined as a gravity of the second power connection portion 3.

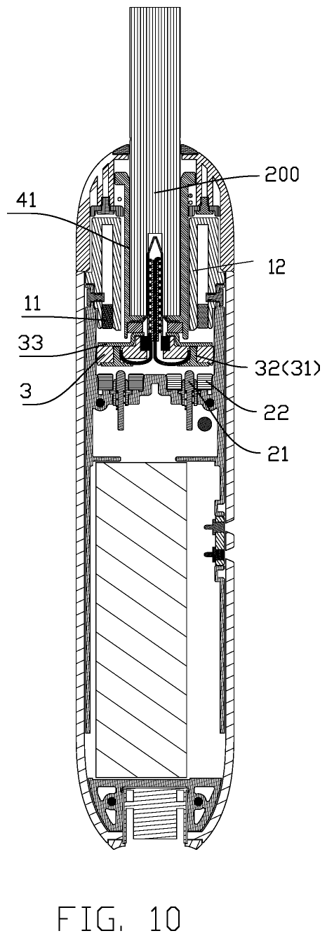

Referring to FIG. 9, the fourth magnetic part 11 attracts the third magnetic part 33 to keep the second electric terminal 31 separated from the first electric terminal 21 in a power-off state. As shown in FIG. 10, when a cigarette in the receiving cavity 41 is pushed downward or a cigarette is inserted downward toward the receiving cavity 41, an adsorption force between the fourth magnetic part 11 and the third magnetic part 33 is destroyed. After that, as shown in FIG. 11, under an action of an adsorption force between the second magnetic part 22 and the first magnetic part 32, the second power connection portion 3 can move downward so that the second electric terminal 31 and the first electric terminal 21 can be automatically attracted together and the heating circuit 5 can be in an energized state shown in FIG. 11.

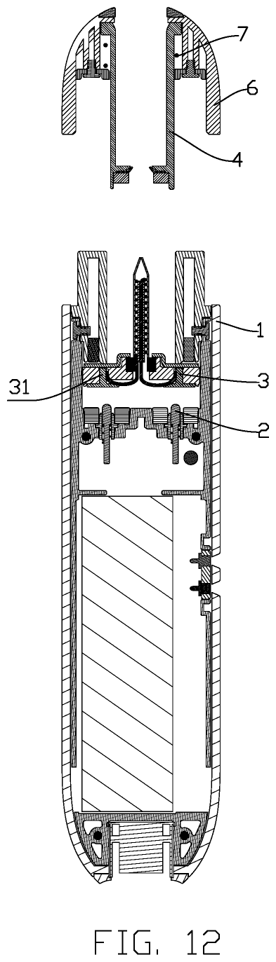

When it is necessary to take out the cigarette, if the electronic heating device 100 is in the energized state shown in FIG. 11, the cover 6 needs to be pulled upward with a force FX first to separate the second electric terminal 31 and the first electric terminal 21, and then the electronic heating device 100 is in the power-off state shown in FIG. 9. After the electronic heating device 100 returns to the power-off state shown in FIG. 9, the cover 6 needs to be pulled upward with a force FY again to remove the cover 6 and the storage cup 4 separated from the housing 1 together, the electronic heating device 100 is in a state shown in FIG. 12.

In order to realize the above functions, first, the following conditions should be satisfied: (1) F2−F7>F8, (2) F6+F2>F8, (3) F2−F7>F4+F8, and (4) FX=F2−F7−F4−F8+F9. The above conditions are used to ensure that in the energized state shown in FIG. 11, when the cover 6 is pulled upward with the force FX, the second electric terminal 31 can be separated from the first electric terminal 21, and the second electric terminal 31 can automatically move upward to the second position and can be maintained in the second position, then the cover 6 can automatically fall back to a state of being assembled with the housing 1 under an action of the resetting member 7. That is, the electronic heating device 100 can automatically returned from the energized state shown in FIG. 11 to the power-off state shown in FIG. 9 by applying the force FX.

Second, the following conditions should be satisfied: (5) F4>F2−F7+G, and (6) FY=F6+F8. The above conditions are used to ensure that in the power-off state shown in FIG. 9, when the cover 6 is pulled upward with the force FY, the cover 6 and the storage cup 4 can be separated from the housing 1 together, that is, the electronic heating device 100 can be realized from the power-off state shown in FIG. 9 to the state that the cover 6 is pulled out as shown in FIG. 12.

Third, the following condition should be satisfied: (5) F4>F2−F7+G. The above condition is used to ensure that in the state that the cover 6 is pulled out as shown in FIG. 12, the second electric terminal 31 can be stably stay in the current second position.

In the description of the present application, the terms “one embodiment”, “some embodiments”, “illustrative embodiment”, “example”, “specific example”, or “some example” refer to the specific features, structures, materials, or features described in conjunction with the embodiments or examples included in at least one embodiment or example of this application. In this specification, the schematic expressions of the above terms do not necessarily refer to the same implementation or example. Moreover, the specific features, structures, materials, or characteristics described can be combined in an appropriate manner in any one or more embodiments or examples.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An electronic heating device comprising:
a housing;
a first power connection portion arranged in the housing and comprising a first electric terminal;
a second power connection portion arranged in the housing and comprising a second electric terminal, wherein the second electric terminal is movable between a first position and a second position in a direction toward or away from the first electric terminal respectively, the second electric terminal is in electrically contact with the first electric terminal when the second electric terminal is at the first position, the electric terminal is disconnected from the first electric terminal when the second electric terminal is at the second position;
a storage cup, wherein the storage cup comprises a receiving cavity configured for storing a to-be-heated member, the storage cup is movable in the direction toward or away from the first electric terminal to drive the second electric terminal to move between the first position and the second position respectively; and
a heating circuit, configured for heating the receiving cavity, wherein the first electric terminal and the second electric terminal are electrically connected to the heating circuit.

2. The electronic heating device of claim 1, wherein the first power connection portion and the storage cup are respectively located on opposite sides of the second power connection portion across the direction that the second electric terminal is moving.

3. The electronic heating device of claim 1, further comprising a first locking portion, wherein the first locking portion is configured to lock the second electric terminal at the first position when the second electric terminal is at the first position.

4. The electronic heating device of claim 3, wherein the first locking portion is further configured to lock the second electric terminal at the first position by a magnetic attraction force, the first locking portion comprises a first magnetic part and a second magnetic part configured to magnetically cooperate with the first magnetic part, the first magnetic part is provided by the second power connection portion, and the second magnetic part is provided by the first power connection portion.

5. The electronic heating device of claim 4, wherein an end of the second power connection portion facing the first power connection portion comprises the first magnetic part.

6. The electronic heating device of claim 4, wherein the first magnetic part and the second electric terminal are integrated into a piece.

7. The electronic heating device of claim 1, further comprising a second locking portion, wherein the second locking portion is configured to lock the second electric terminal at the second position when the second electric terminal is at the second position.

8. The electronic heating device of claim 7, wherein the second locking portion is further configured to lock the second electric terminal at the second position by a magnetic attraction force, the second locking portion comprises a third magnetic part and a fourth magnetic part configured to magnetically cooperate with the third magnetic part, the third magnetic part is provided by the second power connection portion, and the fourth magnetic part is provided by the housing.

9. The electronic heating device of claim 8, wherein an end of the second power connection portion facing away from the first power connection portion comprises the third magnetic part.

10. The electronic heating device of claim 8, wherein the housing further comprises a frame configured for supporting the storage cup, and the fourth magnetic part is located on the frame.

11. The electronic heating device of claim 1, further comprising a third locking portion, wherein the third locking portion is configured to detachably connect the second power connection portion and the storage cup to realize detachably connection between the storage cup and the housing.

12. The electronic heating device of claim 11, wherein the third locking portion is further configured to lock the second power connection portion to the storage cup by a magnetic attraction force, the third locking portion comprises a fifth magnetic part and a sixth magnetic part configured to magnetically cooperate with the fifth magnetic part, and the fifth magnetic part is provided by the second power connection portion, the sixth magnetic part is provided by the storage cup.

13. The electronic heating device of claim 12, wherein an end of the second power connection portion facing the storage cup comprises the fifth magnetic part.

14. The electronic heating device of claim 11, further comprising a cover located at an end of the housing, wherein the cover is located on a side of the second electric terminal away from the first position in a moving direction of the second electric terminal, the cover is detachably mounted on the housing, the storage cup is installed on the cover, and the storage cup is removed from the housing when the cover is removed from the housing.

15. The electronic heating device of claim 14, wherein the storage cup is movably installed on the cover, the electronic heating device further comprises a resetting member between the storage cup and the cover, when the storage cup is moved to drive the second electric terminal to move toward the first position, the resetting member is compressed, and when the resetting member reflexes, the second electric terminal is moved toward the second position.

16. The electronic heating device of claim 14, wherein the cover is movably mounted on the housing, the cover and the storage cup are configured to synchronously move, the electronic heating device further comprises a resetting member between the housing and the cover, when the storage cup is moved to drive the second electric terminal to move toward the first position, the resetting member is compressed, and when the resetting member reflexes, the second electric terminal is moved toward the second position.

17. The electronic heating device of claim 11, wherein the second power connection portion further comprises a support base configured for mounting the second electric terminal, and the heating circuit comprises a heating element fixed to the support base, the heating element is configured for heating the receiving cavity.

18. The electronic heating device of claim 17, wherein the heating element partially extends into the storage cup, and an extending direction of the heating element that is inside the storage cup is to the same as a moving direction of the storage cup.

19. The electronic heating device of claim 18, further comprising a cleaning blade arranged in the storage cup, wherein the cleaning blade comprises a scraping head configured for abutting against the heating element, when the storage cup is removed from the housing, the heating element is scraped by the cleaning blade as the storage cup moves.

20. The electronic heating device of claim 19, wherein an end of the storage cup facing the second power connection portion comprises an end surface, and the end surface defines a through hole, the heating element is movably inserted into the storage cup through the through hole, and the cleaning blade is arranged in the through hole and surrounds the heating element.
